(19) United States
(12) Patent Application Publication
(10) Pub. No.: US 2010/0093209 A1
(43) Pub. Date: Apr. 15, 2010

(54) ELECTRICAL CONNECTOR ASSEMBLY WITH IMPROVED RESISTING STRUCTURE TO ENSURE RELIABLE CONTACTING BETWEEN GROUND SHIELDS THEREOF

(75) Inventors: HONG-TAO LIU, Kunshan (CN); CHIH-MING CHIEN, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/577,234

(22) Filed: Oct. 12, 2009

(30) Foreign Application Priority Data
Oct. 15, 2008 (CN) 200820302423.9
Oct. 15, 2008 (CN) 200820302433.2
Oct. 16, 2008 (CN) 200810195575.8

(51) Int. Cl. H01R 13/66

(52) U.S. Cl. 439/541.5

(57) ABSTRACT

An electrical connector assembly includes a header and a receptacle mateable with the header. The header includes a receiving space, a number of header contacts and a header ground shield located between the header contacts in adjacent two columns. The receptacle includes a number of contact modules to be received in the receiving space. At least one of the contact modules includes an insulator, a receptacle ground shield fixed in the insulator and a plurality of receptacle contacts for mating with the header contacts. A mating portion of the insulator includes a supporting rib resisting against the header ground shield in order to enhance mating force between the header ground shield and the receptacle ground shield when the receptacle is inserted into the receiving space of the header.

### BACKGROUND OF THE INVENTION

1. Field of the Invention

The present invention relates to an electrical connector assembly for transmitting high speed signals, and more particularly to an electrical connector assembly having improved resisting structure to ensure reliably contacting between ground shields of a header and a receptacle.

2. Description of Related Art

U.S. Pat. No. 6,299,483 issued to Cohen on Oct. 9, 2001 discloses a high speed electrical connector assembly for electrically connecting printed circuit boards. The connector assembly includes a header and a receptacle for mating with the header. The header has a plurality of pins and shielding plates. Each shielding plate is stamped to form a plurality of serpentine arms. The receptacle includes a plurality of wafers aligned in parallel fashion. Each wafer includes a ground shield and a first insulative housing molded over a front portion of the ground shield. The first insulative housing defines a plurality of passageways. The wafer further has a plurality of contacts molded in a second insulative housing. Each contact has a forked contacting portion extending forwardly beyond the second insulative housing to be inserted into the passageways of the first insulative housing. It is obvious that assembling all the contacting portions into the corresponding passageways simultaneously is not a easy process, which may decrease manufacture efficiency thereof. Besides, with insertion of the wafers into the header, the ground shields of the receptacle abut against the arms of the header in order to decrease cross-talk in signal transmission. Although the serpentine arms of the header shielding plate provide good flexibility, there is still a potential condition that the arms may be of over-deformation after frequently insertion of the receptacle into the header.

Hence, an improved electrical connector assembly is needed to solve the above problems.

### BRIEF SUMMARY OF THE INVENTION

An electrical connector assembly comprises a header and a receptacle mateable with the header. The header includes a header housing defining a base, a pair of side walls extending from the base and a receiving space formed between the side walls. A plurality of header contacts are fixed in the base in columns and rows and comprise a plurality of contact portions protruding into the receiving space. At least one header ground shield is located between the header contacts in adjacent two columns. The header ground shield comprises a main section protruding into the receiving space. The receptacle comprises a plurality of contact modules stacked side-by-side. At least one of the contact modules comprises an insulator, a receptacle ground shield fixed in the insulator and a plurality of receptacle contacts. The insulator has a mating portion extending a predetermined length to be received in the receiving space of the header. The receptacle ground shield has a plurality of contacting portions exposed to an exterior through a first side surface of the insulator. The receptacle contacts have contacting sections exposed to the exterior through a second side surface of the insulator opposite to the first side surface. The mating portion of the insulator comprises a supporting rib sidewardly extending beyond the second side surface under a condition that, when the receptacle is inserted into the receiving space of the header, the supporting rib resists against the main section of the header ground shield in order to enhance mating force between the header ground shield and the contacting portions of the receptacle ground shield.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an electrical connector assembly with a receptacle and a header apart from each other in accordance with a preferred embodiment of the present invention;

FIG. 2 is an assembled perspective view of the electrical connector assembly as shown in FIG. 1 while with the receptacle mated with the header;

FIG. 3 is a partly exploded view of the header as shown in FIG. 1, from which a header ground shield is disassembled;

FIG. 4 is a partly exploded view of the receptacle as shown in FIG. 1, from which a contact module is disassembled;

FIG. 5 is a perspective view of the contact module as shown in FIG. 4;

FIG. 6 is an exploded view of the contact module as shown in FIG. 5;

FIG. 7 is another exploded view of the contact module shown in FIG. 6, while taking from another aspect;

FIG. 8 is a perspective view showing the contact module mated with the plug ground shield; and

FIG. 9 is a schematic cross-sectional view of the electrical connector assembly.

### DETAILED DESCRIPTION OF THE PREFERRED EMBODIMENT

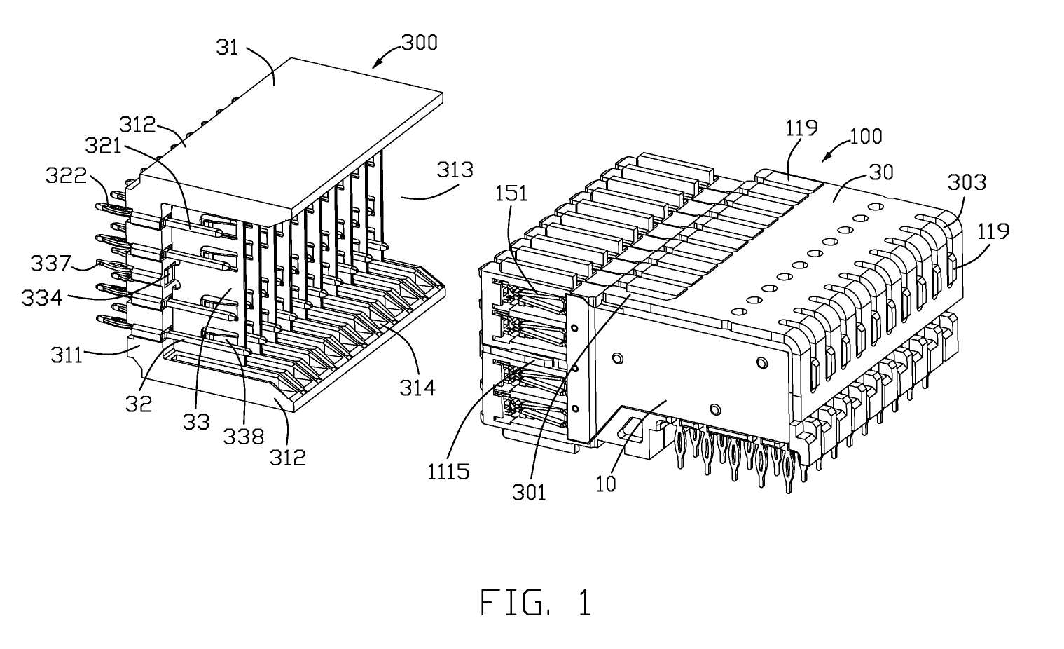

Reference will now be made to the drawing figures to describe the preferred embodiment of the present invention in detail. FIGS. 1-3 illustrate a high speed electrical connector assembly 1 including a receptacle 100 and a header 300 for mating with the receptacle 100. The receptacle 100 is attached to a backplane (not shown) and the header 300 is attached to a daughter card (not shown) perpendicular to the backplane.

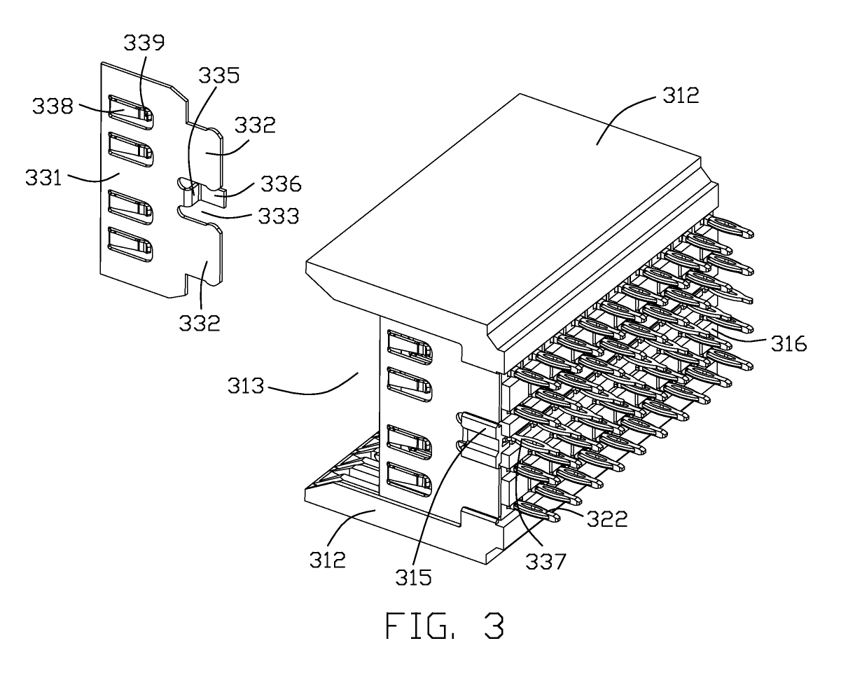

The header 300 includes a header housing 31, a plurality of header contacts 32 fixed in the header housing 31 in columns and rows, and a plurality of header ground shields 33 located between the header contacts 32 arranged in each adjacent two rows. The header housing 31 is U-shaped and includes a base 311 and a pair of side walls 312 extending from lateral sides of the base 311. The pair of side walls 312 define with the base 311 a receiving space 313 for receiving the receptacle 100. Each side wall 312 defines a plurality of guiding grooves 314 formed on an inner side thereof for guiding insertion of the receptacle 100. Each header contact 32 has a retention portion (not labeled) fixed in the base 311, a rectangular contact portion 321 protruding into the receiving space 313 and a press-fit portion 322 extending downwardly beyond a mounting surface 316 of the base 311 to be pressed into holes (not shown) defined in the daughter card. The contact portions 321 in each column have different length protruding into the receiving space 313 as best shown in FIG. 1. Each header ground shield 33 is plate shaped and includes a main section 331 protruding into the receiving space 313 and a pair of fixing tabs 332 extending from the main section 331 with a slit 333 formed between the fixing tabs 332. Besides, the header ground shield 33 includes a L-shaped tab 334 disposed corresponding to the slit 333 while bending sidewardly beyond the slit 333. The L-shaped tab 334 includes a first section 335 perpendicular to the main section 331 and a second section 336 parallel to the main section 331. The second section 336 and the main section 331 are located on different planes and the second section 336 is mechanically connected to a ground tab (not labeled) as best shown in FIG. 3. The ground tab has a plurality of ground tail portions 337 one of which is aligned with the press-fit portions 322 in the adjacent row. In order to fix the header ground shield 33 in the header housing 31, the base 311 includes a protrusion 315 fixed in the slit 333. The main section 331 further defines a plurality of cantilevered spring arms 338 sidewardly extending beyond the main section 331. Each spring arm 338 has a curved contacting section 339 which is plated with gold or other materials in order to establish stable connection with the receptacle 100. As one aspect of the present invention, the spring arm 338 with the curved contacting section 339 may easily plate gold on an outer surface of the curved contacting section 339 to avoid invalid plating area of the main section 331. As a result, manufacture cost of the header ground shield 33 can be decreased.

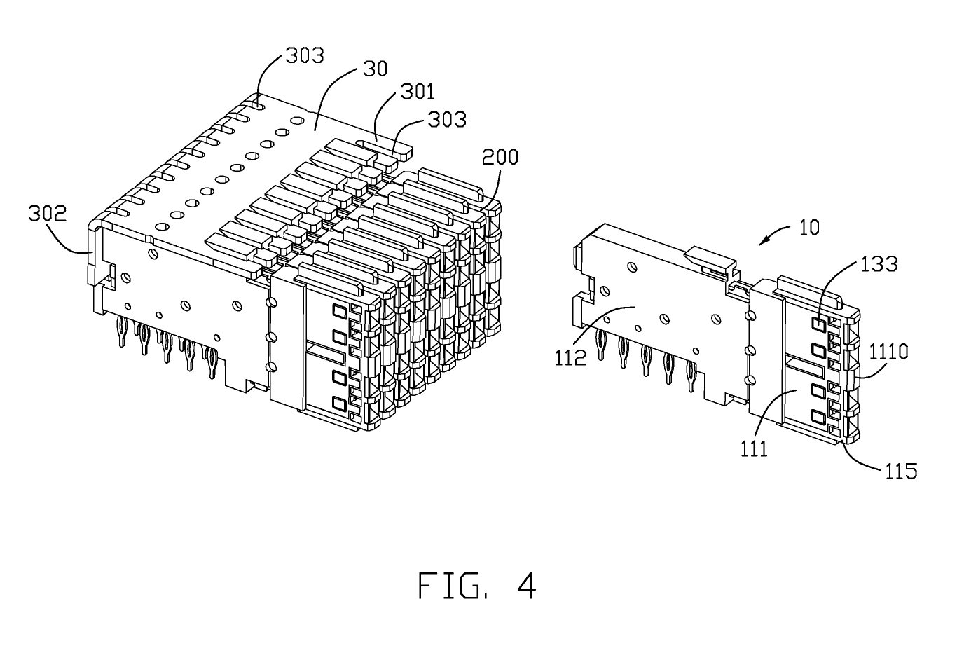

Referring to FIGS. 1 and 4, the receptacle 100 includes a plurality of contact modules 10 stacked side-by-side in parallel rows and an outer organizer 30 for organizing the contact modules 10. A gap 200 is formed between the adjacent two contact modules 10 for receiving the header ground shield 33. The organizer 30 is L-shaped from a side view and includes a horizontal section 301 and a vertical section 302. Both the horizontal section 301 and the vertical section 302 define a plurality of slots 303 formed therethrough.

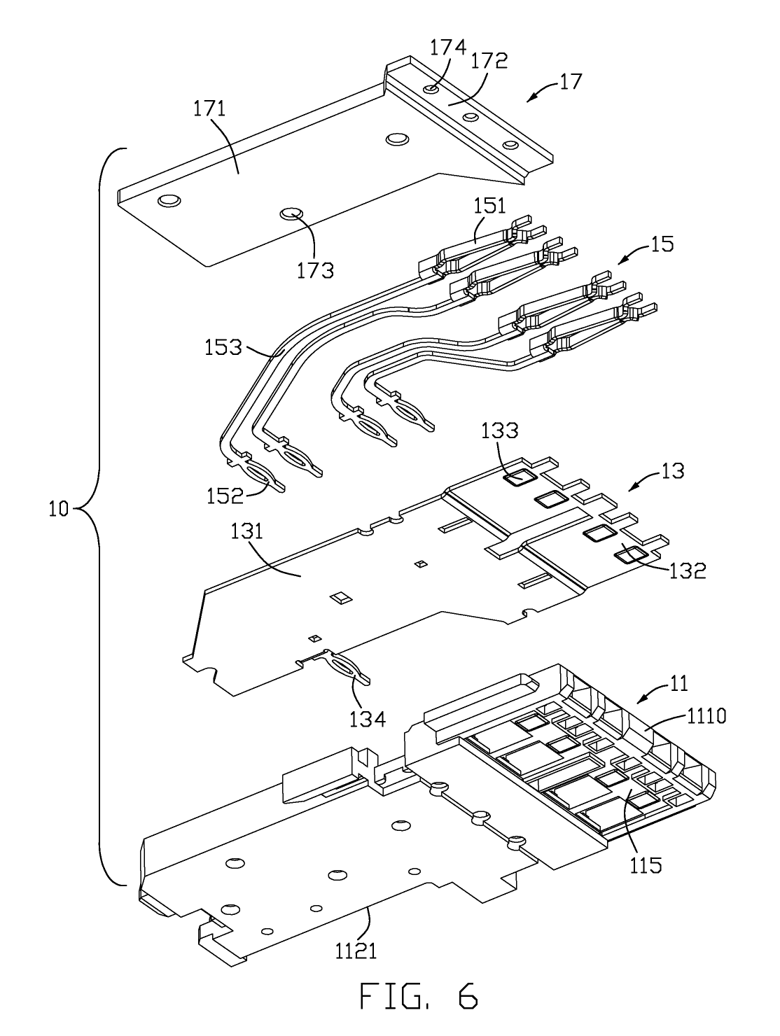

Referring to FIGS. 4-7, each contact module 10 includes a main insulator 11, a receptacle ground shield 13 insert-molded with the insulator 11, a plurality of receptacle contacts 15 assembled to the insulator 11, and an insulative cover 17 attached to the insulator 11 with the receptacle contacts 15 sandwiched therebetween. The insulator 11 includes a mating portion 111 extending a predetermined distance to be inserted into the receiving space 313 of the header 300 and a base portion 112 backwardly extending from the mating portion 111. The base portion 112 includes a mounting surface 1121 mounted to the backplane and a plurality of ribs 119 formed at top and rear sides thereof to be fixed in the slots 303 of the organizer 30. Opposite first and second side surfaces 115, 116 are formed on the insulator 11. The base portion 112 defines a receiving chamber 113 recessed from the second side surface 116 and forming a mounting wall 114 disposed between the first and the second side surfaces 115, 116. The mounting wall 114 further defines a plurality of sinuous first passageways 1141 communicating with the receiving chamber 113 and further extending through the mounting surface 1121. A plurality of first positioning posts 1142 are formed protruding from the mounting wall 114 into the receiving chamber 113 for mating with the insulative cover 17.

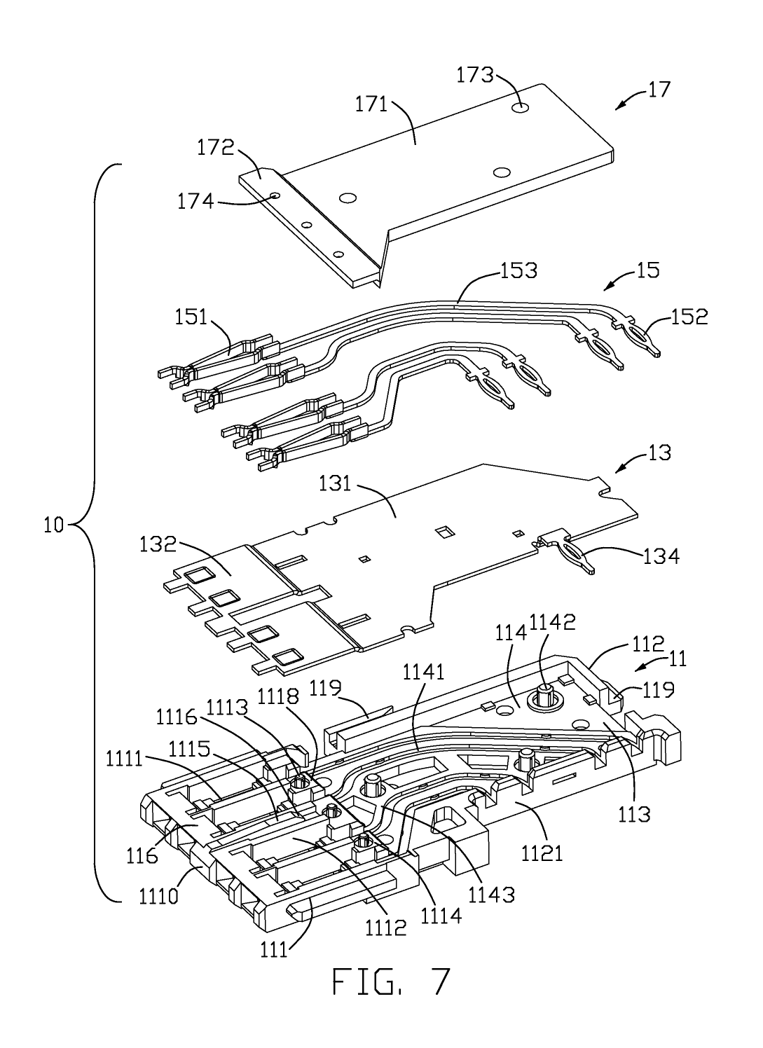

The mating portion 111 defines a plurality of second passageways 1111 extending through the second side surface 116 and a plurality of separating walls 1112 separating the adjacent second passageways 1111. The first and the second passageways 1141, 1111 are communicating with each other for corporately receive the receptacle contacts 15. The mating portion 111 include a plurality of embosses 1118 protruding beyond the mounting wall 114. A plurality of second positioning posts 1113 protrude beyond the embosses 1118 and towards the second side surface 116 for mating with the insulative cover 17. As shown in FIG. 7, an out surface 1114 of each emboss 1118 is much nearer to the second side surface 116 than another out surface 1143 of the mounting wall 114. That is to say, the configuration of the insulator 11 exposed to the second side surface 116 is step shaped. The mating portion 111 further includes a cantilevered arm 1115 extending from a front tip end 1110 to the base portion 112. The cantilevered arm 1115 defines a free end 1116 near the base portion 112. The cantilevered arm 1115 is disposed between the adjacent two second passageways 1111 and further protrudes sidewardly beyond the second side surface 116. The function of the cantilevered arm 1115 will be detailed hereinafter.

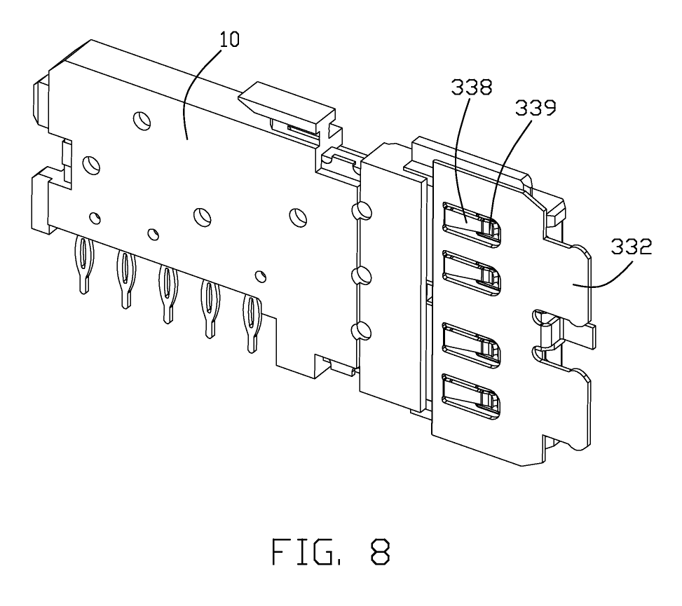

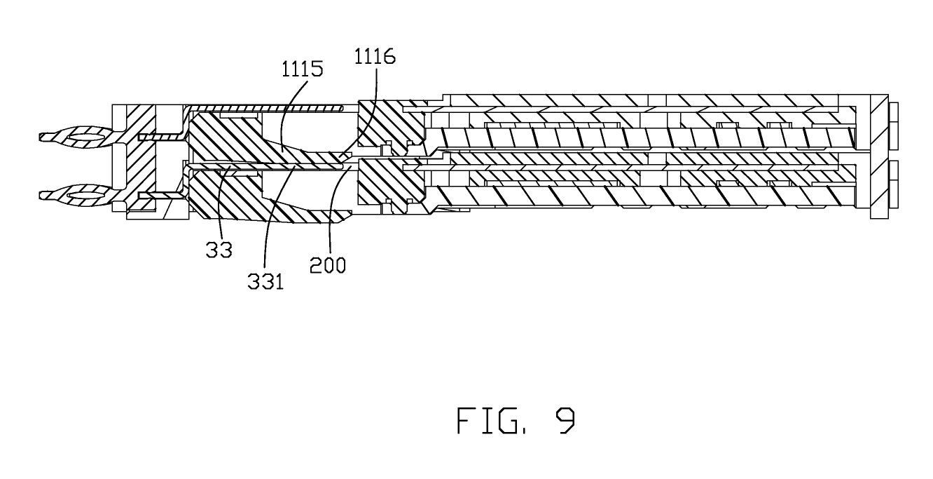

The receptacle ground shield 13 is plate shaped and is insert-molded with the insulator 11. The receptacle ground shield 13 includes a main body 131 embedded between the mounting wall 114 and the first side surface 115, an extension 132 extending forwardly from the main body 131 and a mounting tail 134 extending downwardly beyond the main body 131. The extension 132 is stamped sidewardly to form a plurality of plate contacting portions 133 exposed to the gap 200 through the first side surface 115. The contacting portion 133 of this configuration may easily be plated with a thin layer gold or something simulating gold on an outer surface thereof to avoid invalid plating area of the extension 132. Referring to FIGS. 8-9, with insertion of the receptacle 100 into the receiving space 313 of the header 300, each header ground shield 33 is accommodated in the gap 200 under a status that the curved contacting sections 339 of the spring arms 338 abut against the corresponding plate contacting portions 133 of the receptacle ground shield 13 in order to decrease cross-talk during high speed signal transmission. Both the curved contacting sections 339 and the plate contacting portions 133 are plated with gold or the like in order to establish excellent resisting characteristics therebetween. Meanwhile, as best shown in FIG. 9, the free ends 1116 of the cantilevered arms 1115 resist against the main section 331 of the header ground shield 33 in order to enhance the mating force between the header and the receptacle ground shields 33, 13.

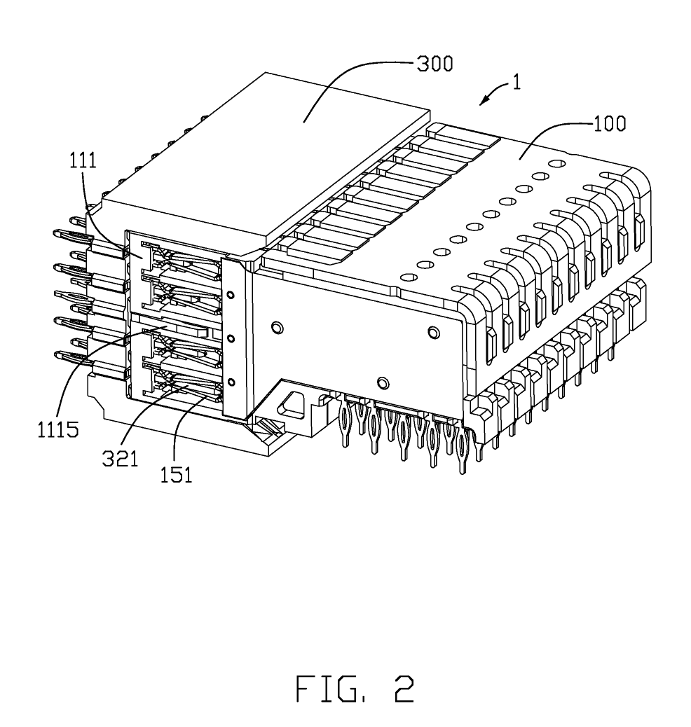

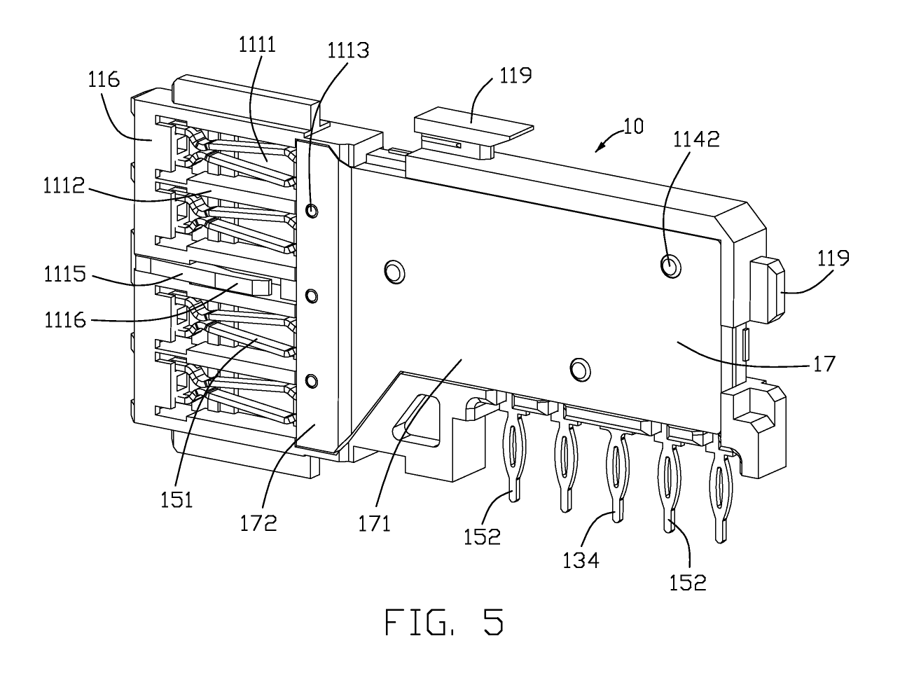

Referring to FIGS. 5-7, the receptacle contacts 15 are arranged in differential pairs for transmitting the high speed signals. Each receptacle contact 15 is substantially right-angled and includes a bifurcate contacting section 151, a press-fit tail section 152 substantially perpendicular to the contacting section 151 and an interconnected section 153 connected with the contacting section 151 and the tail section 152. The receptacle contacts 15 are assembled to the insulator 11 with the contacting sections 151 received in the corresponding second passageways 1111 and with the interconnected section 153 received in the first passageways 1141. The tail sections 152 of the receptacle contacts 15 are aligned with the mounting tail 134 of the receptacle ground shield 13 in the same contact module 10. The tail sections 152 and the mounting tail 134 extend beyond the mounting surface 1121 to be pressed into holes defined in the backplane. As shown in FIG. 2, during mating status, the contact portions 321 of the header contacts 32 extend through the front tip end 1110 of the mating portion 111 to be finally clipped by the bifurcate contacting sections 151.

The insulative cover 17 is step shaped and includes a plate portion 171 and an elevated front portion 172 extending from the plate portion 171. The plate portion 171 and the front portion 172 define a plurality of first and second mounting holes 173, 174, respectively. The insulative cover 17 is configured to and is received in the receiving chamber 113 in order to shield the interconnected sections 153 of the receptacle contacts 15. The first and the second positioning posts 1142, 1113 are fixed in the first and the second mounting holes 173, 174 so that the insulative cover 17 can be received in the receiving chamber 113 more stably. The front portion 172 straddles the embosses 1118 of the insulator 11 and is located at the rear of the bifurcate contacting sections 151. According to another aspect of the present invention, the separated insulator 11 and the insulative cover 17 can be selectively made of different materials as a result that the impedance of the receptacle contacts 15 can be easily adjusted.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An electrical connector assembly comprising:
a header and a receptacle mateable with the header;
the header comprising:
a header housing having a base, a pair of side walls extending from the base and a receiving space formed between the side walls;
a plurality of header contacts fixed in the base in columns and rows and each comprising a contact portion protruding into the receiving space; and
at least one header ground shield located between the header contacts in adjacent two columns, the header ground shield comprising a main section protruding into the receiving space;
the receptacle comprising:
a plurality of contact modules stacked side-by-side, at least one of the contact modules comprising:
an insulator having a mating portion extending a predetermined length to be received in the receiving space of the header;
a receptacle ground shield fixed in the insulator and having a plurality of contacting portions exposed to an exterior through a first side surface of the insulator; and
a plurality of receptacle contacts having contacting sections exposed to the exterior through a second side surface of the insulator opposite to the first side surface; wherein
the mating portion of the insulator comprises a supporting rib sidewardly extending beyond the second side surface under a condition that, when the receptacle is inserted into the receiving space of the header, the supporting rib resists against the main section of the header ground shield in order to enhance mating force between the header ground shield and the contacting portions of the receptacle ground shield.

2. The electrical connector assembly as claimed in claim 1, wherein the supporting rib comprises a cantilevered arm extending along a direction opposite to that of the contacting sections, the cantilevered arm defining a free end resisting against the main section of the header ground shield.

3. The electrical connector assembly as claimed in claim 1, wherein the main section of the header ground shield comprises a plurality of spring arms sidewardly extending beyond the main section, the contacting portions being stamped sidewardly beyond the receptacle ground shield, each spring arm having a curved contacting section to abut against corresponding contacting portion of the receptacle ground shield.

4. The electrical connector assembly as claimed in claim 3, wherein the spring arms and the contacting portions are plated with a metal layer.

5. The electrical connector assembly as claimed in claim 1, wherein the contact portions of the header contacts are rectangular shaped, the contact portions in each column having different protruding lengths into the receiving space, the contacting sections of the receptacle contacts being bifurcate, and the contact portions of the header contacts extending through a front tip end of the insulator to be clipped by the contacting sections.

6. The electrical connector assembly as claimed in claim 1, wherein the header ground shield comprises a pair of fixing tabs extending from the main section, a slit formed between the fixing tabs, and a L-shaped tab disposed corresponding to the slit and bent sidewardly beyond the slit, the L-shaped tab comprising a first section perpendicular to the main section and a second section parallel to the main section, the second section and the main section being located on different planes, the header contacts in one of the adjacent two columns comprising a plurality of press-fit portions connecting the contact portions, the second section being mechanically connected to a detachable ground tail portion which is aligned with the press-fit portions.

7. The electrical connector assembly as claimed in claim 1, wherein the receptacle contacts comprise tail sections substantially perpendicular to the contacting sections and interconnected sections connected with the contacting sections and the tail sections, the insulator comprising a base portion extending from the mating portion, the base portion and the mating portion defining a plurality of first and second passageways, respectively, to assemble the contacting sections and the interconnected sections.

8. The electrical connector assembly as claimed in claim 7, wherein the base portion of the insulator defines a receiving chamber concaved from the second side surface and communicating with the first passageways, the receptacle comprising an insulative cover received in the receiving chamber to shield the interconnected sections while leaving the contacting portions exposed.

9. The electrical connector assembly as claimed in claim 7, wherein the receptacle ground shield is insert-molded with the insulator and comprises a mounting tail aligned with the tail sections of a same column.

10. An electrical connector, comprising:
an organizer; and
a plurality of contact modules stacked side-by-side and regulated by the organizer, at least one of the contact modules comprising:
an insulator having a base portion and a mating portion extending from the base portion, the insulator defining opposite first and second side surfaces and a receiving chamber concaved from the second side surface, the base portion and the mating portion defining a plurality of first and second passageways, respectively, under a condition that the first passageways communicate with the receiving chamber;
a plurality of receptacle contacts having contacting sections received in the second passageways, interconnected sections received in the first passageways and tail sections extending beyond the insulator, each interconnected section connecting the corresponding contacting section and the tail section, the contacting sections being exposed to an exterior through the second side surface;
a receptacle ground shield fixed in the insulator and comprising a plurality of raised contacting portions exposed to the exterior through the first side surface; and
an insulative cover received in the receiving chamber to shield the interconnected sections of the receptacle contacts while leaving the contacting sections always expose to the air.

11. The electrical connector as claimed in claim 10, wherein the receptacle ground shield is insert-molded with the base portion and the mating portion.

12. The electrical connector as claimed in claim 10, wherein the contacting portions of the receptacle ground shield are rectangular shaped and are plated with a metal layer.

13. The electrical connector as claimed in claim 10, wherein the mating portion comprises a cantilevered arm extending along a direction opposite to that of the contacting sections and extending sidewardly beyond the second side surface.

14. The electrical connector as claimed in claim 10, wherein the base portion comprises at least one first positioning post protruding into the receiving chamber, the insulative cover comprising a plate portion defining at least one first mounting hole to accommodate the first positioning post.

15. The electrical connector as claimed in claim 14, wherein the insulator defines the receiving chamber to form a mounting wall disposed between the first and the second side surfaces with the first positioning post extending beyond the mounting wall, the mating portion comprising a plurality of embosses protruding beyond the mounting wall, the insulative cover being step shaped and comprising an elevated front portion extending from the plate portion under a condition that the front portion straddles the embosses and is located at the rear of the contacting sections.

16. The electrical connector as claimed in claim 15, wherein the mating portion comprises at least one second positioning post extending beyond the embosses and the front portion of the insulative cover defines at least one second mounting hole to receive the second positioning post.

17. The electrical connector as claimed in claim 10, wherein the insulator and the insulative cover are made of different materials.

18. An electrical connector assembly comprising:
a first connector including a first insulative housing with a plurality of first contacts therein, each of said first contacts defining a contacting section; and
a second connector including a plurality of contact modules side by side intimately arranged with one another, each of said contact module including an insulator defining a front mating portion and a rear base portion thereof, a plurality of second contacts each including a mating section disposed in the front mating portion and an interconnected section disposed in the base portion, and a metallic ground shield blade having a front part transversely shielding one side of the corresponding mating portion, and rear part transversely shielding the base portion, wherein
said first connector further includes a plurality of metallic ground shield plate each transversely shielding the other side of the corresponding mating portion so as to assure that the contact sections of the first contacts and the mating sections of the corresponding second contacts are mated within the corresponding mating portion with two sided transverse shielding by the corresponding ground shield blade of the second connector and the corresponding ground shield plate of the first connector, respectively.

19. The electrical connector assembly as claimed in claim 18, wherein said contact module further includes an insulative cover transversely shielding the other side of the base portion opposite to the corresponding ground shield blade.

20. The electrical connector assembly as claimed in claim 19, wherein the front part of the ground shield blade is exposed upon the corresponding contact module while the rear part is embedded in the corresponding insulator.
